(19) United States
(12) Patent Application Publication
(10) Pub. No.: US 2017/0352466 A1
(43) Pub. Date: Dec. 7, 2017

(54) Laminated Iron Core Structure and Transformer Including the Same

(71) Applicant: Hitachi Industrial Equipment Systems Co., Ltd., Chiyoda-ku, Tokyo (JP)

(72) Inventors: Makoto SHINOHARA, Tokyo (JP); Kunihiko ANDO, Tokyo (JP); Yoichi AMAKO, Tokyo (JP); Kohei SATO, Tokyo (JP)

(21) Appl. No.: 15/539,775

(22) PCT Filed: Dec. 7, 2015
(86) PCT No.: PCT/JP2015/084231

§ 371 Date: Jun. 26, 2017

(30) Foreign Application Priority Data
May 27, 2015 (JP) 2015-106951

(51) Int. Cl. H01F 27/24; H01F 27/26; H01F 30/10; H01F 30/12

(52) U.S. Cl. CPC H01F 27/24; H01F 30/12; H01F 27/26; H01F 30/10

(57) ABSTRACT

It has been difficult to manufacture a large-capacity transformer having a laminated iron core structure using an amorphous alloy material easily. A laminated iron core structure includes a laminated iron core configured by aligning a plurality of laminated iron core blocks each configured by laminating iron core materials in a direction different from a lamination direction, a first frame extending along an outer periphery of the laminated iron core and a partition plate arranged between the plurality of laminated iron core blocks.

### TECHNICAL FIELD

The present invention relates to a laminated iron core structure and a transformer including the same.

### BACKGROUND ART

Iron core structures of a transformer are roughly classified into a wound iron core and a laminated iron core. The wound iron core is chiefly adopted for a distribution transformer, and the laminated iron core is adopted for small transformer for power electronics and a large-capacity transformer which is larger than the distribution transformer. As iron core materials for transformers, there are a silicon steel sheet and an amorphous alloy. An amorphous transformer adopting the amorphous alloy as the iron core material is known as the transformer which has a smaller loss and better energy consumption efficiency than the silicon steel sheet transformer adopting the silicon steel sheet as the iron core material.

The large-capacity transformer using the amorphous alloy having good energy consumption efficiency is required in recent years, however, it is difficult to manufacture the transformer using the laminated iron core structure due to the following reasons. First, an iron core having a larger cross-sectional area is required for the large-capacity transformer, and the width of the iron core and the thickness of lamination are extremely larger than those of a normal iron core for the transformer. However, the amorphous alloy is the material having a thickness of approximately 1/10 of the silicon steel sheet, and the number of laminations will be enormous for manufacturing the iron core used for the large-capacity transformer. Additionally, a material width of the amorphous alloy which can be manufactured is smaller than a material width necessary for the iron core of the large-capacity transformer, and variations in material widths to be supplied are small in the present technique. Accordingly, there is a case where the material width of the iron core is not sufficient for manufacturing the large-capacity transformer by using the amorphous material.

There exists JP-A-2012-138469 (Patent Literature 1) as a background art in the technical field. This publication discloses that “an amorphous core is made to be self-supported in good condition while improving hang-down at the corner of the core due to its own weight when the core is self-supported, and work efficiency is enhanced by assembling the core and a coil smoothly. In an amorphous transformer including an amorphous core formed of an amorphous material and made to be self-supported substantially vertically in a state of being designated by a core supporting member while placing a lap part at the top, and a coil inserted into the amorphous core, the core supporting member is formed by the core supporting member for supporting a side surface of the amorphous core and a corner supporting member for supporting the corner of the core so as to be integrated with each other, and the core supporting member is placed substantially vertically along at least one side surface of the core.”, however, a method for making the large-capacity transformer is not disclosed.

Also, JP-A-11-186082 (Patent Literature 2) discloses that “a method of manufacturing an amorphous laminated iron core is proposed, in which work efficiency is improved by enabling a unit copolymer formed of copolymer of the ribbon of an amorphous magnetic alloy foil to be made easily. A unit copolymer 10 is formed by cutting a strip copolymer made of plural strips of the amorphous magnetic alloy foil overlapping one another into a specified length. A laminated block 11 of unit copolymers is formed by laminating the unit copolymers which are sequentially formed while shifting positions in a length direction. A leg portion and a yoke portion of the laminated iron core are formed by taking the unit copolymers 10 forming the laminated block 11 sequentially from the top and laminating them on a work bench.”, which discloses the structure of the laminated iron core made of the amorphous alloy, however, the iron core in the description is also one formed by laminating iron core materials with the single width, and it is difficult to manufacture the iron core for the large-capacity transformer.

### CITATION LIST

### Patent Literature

Patent Literature 1: JP-A-2012-138469

Patent Literature 2: JP-A-11-186082

### SUMMARY OF INVENTION

### Technical Problem

It has been difficult to manufacture a large-capacity transformer with a laminated iron core structure by using an amorphous alloy easily.

### Solution to Problem

In order to solve the above problems, for example, structures described in claims are adopted. The present application includes plural means for solving the above problems, and an example thereof is cited as follows: A laminated iron core structure according to the invention includes a laminated iron core configured by aligning a plurality of laminated iron core blocks each configured by laminating iron core materials in a direction different from a lamination direction, a first frame extending along an outer periphery of the laminated iron core and a partition plate arranged between the plurality of laminated iron core blocks.

### Advantageous Effects of Invention

The large-capacity transformer of the laminated iron core structure can be easily manufactured by using the amorphous alloy.

### BRIEF DESCRIPTION OF DRAWINGS

FIG. 1 is a front view of an inside of a transformer according to a first embodiment of the invention.

FIG. 2 is a side view of the inside of the transformer according to the first embodiment of the invention.

FIG. 3a is a perspective view of a laminated body of an iron core used for the transformer according to the first embodiment of the invention.

FIG. 3b is a front view of a first laminated block of the iron core used for the transformer according to the first embodiment of the invention.

FIG. 3c is a front view of a second laminated block of the iron core used for the transformer according to the first embodiment of the invention.

FIG. 3d is a front view of a laminated body of the first laminated block and the second laminated block of the iron core used for transformer according to the first embodiment of the invention.

FIG. 4 is a cross-sectional view of a leg portion of the iron core used for transformer according to the first embodiment of the invention.

FIG. 5 is a cross-sectional view of a yoke portion of the iron core used for transformer according to the first embodiment of the invention.

FIG. 6 is a perspective view of an iron core fixing metal fitting according to the first embodiment of the invention.

FIG. 7 is a front view of a laminated body of the iron core according to a second embodiment.

FIG. 8 is a front view of a laminated body of the iron core according to a third embodiment.

FIG. 9 is a front view of a laminated body of the iron core according to a fourth embodiment.

FIG. 10 is a cross-sectional view of a leg portion of the iron core according to a fifth embodiment.

FIG. 11 is a cross-sectional view of a leg portion of the iron core according to a sixth embodiment.

FIG. 12 is a cross-sectional view of a leg portion of the iron core according to a seventh embodiment.

FIG. 13 is a cross-sectional view of a yoke portion of the iron core according to an eighth embodiment.

FIG. 14 is a cross-sectional view of a leg portion of the iron core according to a ninth embodiment.

### DESCRIPTION OF EMBODIMENTS

Hereinafter, the invention will be explained by respective embodiments with reference to the drawings.

### Embodiment 1

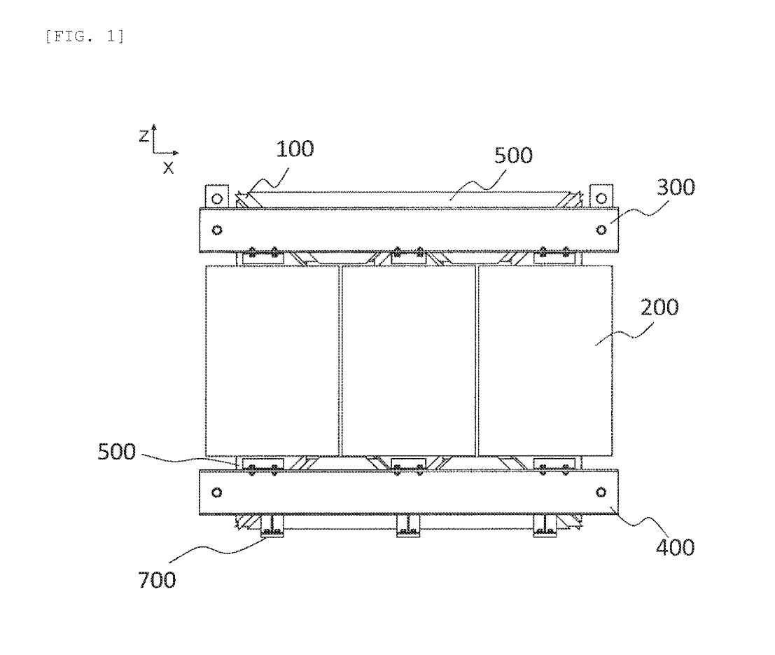

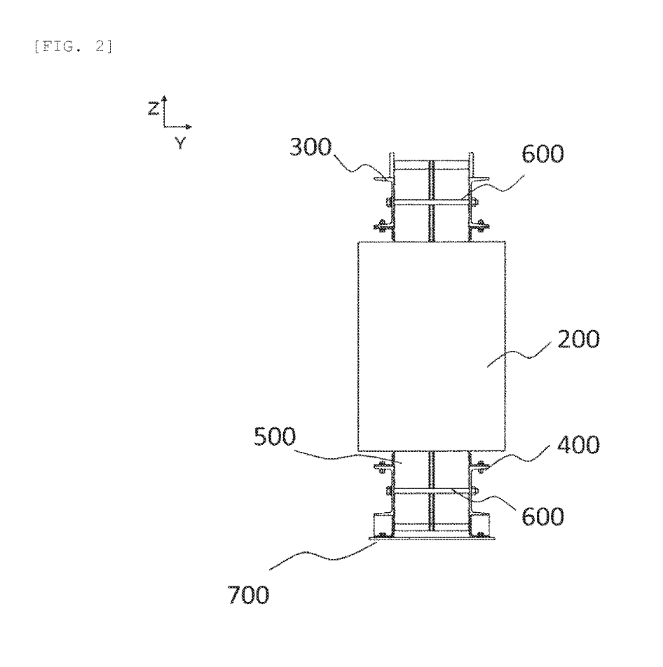

Embodiment 1 of the invention will be explained with reference to FIG. 1 to FIG. 6. An inner structure of a transformer according to Embodiment 1 will be explained in FIG. 1 and FIG. 2. FIG. 1 is a front view and FIG. 2 is a side view. The inner structure of the transformer according to the invention includes an iron core 100, a coil 200, upper fasteners 300, lower fasteners 400, a core fixing metal fitting 500, fastener fastening studs 600 and a base 700. The core fixing metal fitting 500 is a tubular member having a square shape in cross section which surrounds a circumference of the laminated iron core 100, which is arranged so as to penetrate the coil 200. The upper fasteners 300 and the lower fasteners 400 are fastened by the fastener fastening studs 600, thereby fixing the iron core 100 arranged in the core fixing metal fitting 500. The core fixing metal fitting 500 is further fixed to the upper fasteners 300 and the lower fasteners 400 by bolts. The lower fasteners 400 are fixed to the base 700 arranged at the bottom by bolts.

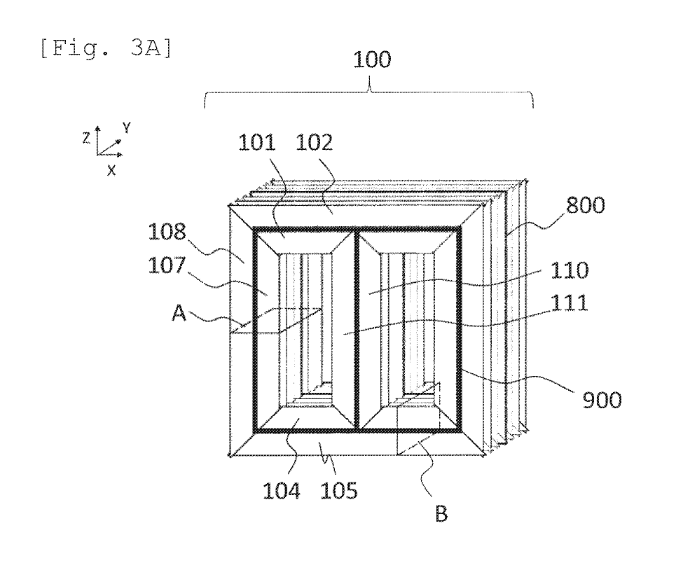

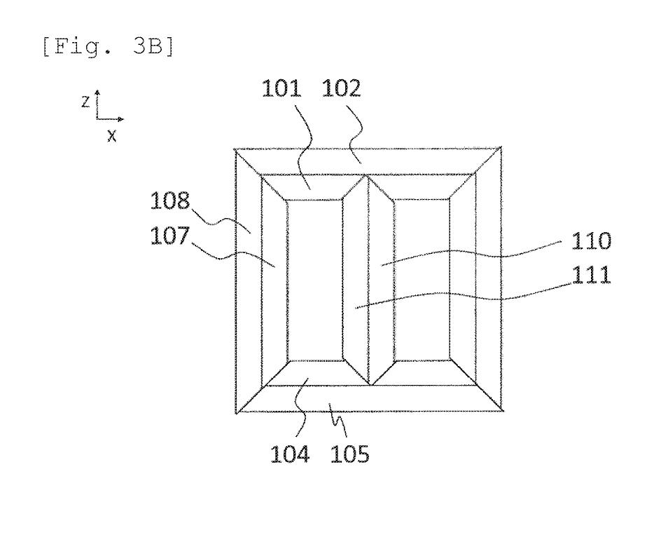

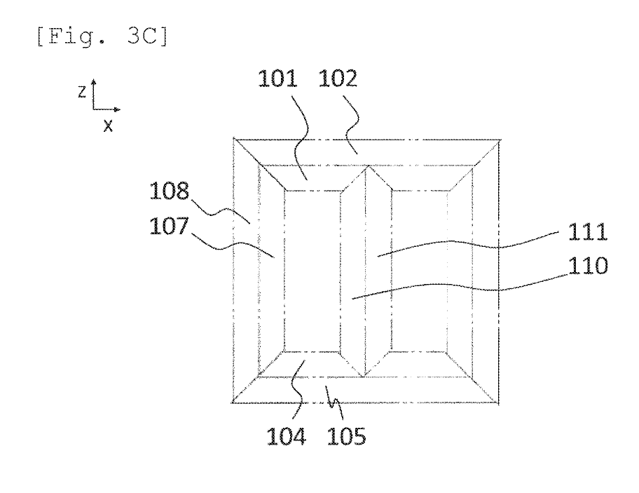

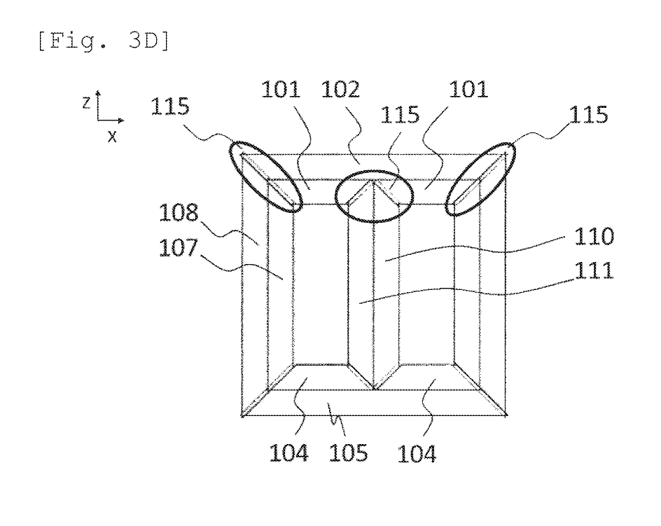

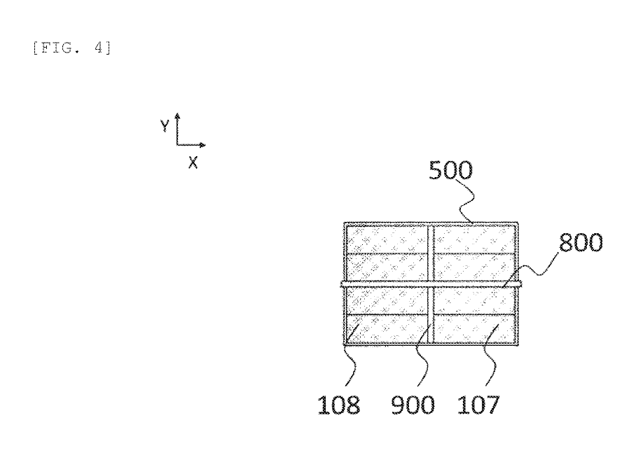

FIG. 3(a) is a perspective view of the iron core 100 depicted in FIG. 1, which shows a state where the coil 200, the upper fasteners 300, the lower fasteners 400, the core fixing metal fitting 500 and the base 700 are removed from FIG. 1. The iron core 100 is formed by aligning an iron core material 107 and an iron core material 108 with a prescribed width in parallel, in which plural plate-shaped iron core materials are laminated in a Y-axis direction. In the case where a thin material such as an amorphous alloy material is used as the iron core material, for example, approximately 15 to 20 pieces of materials are set as one lamination unit (hereinafter expressed as a laminated block) and plural number of laminated blocks are further laminated to form the iron core 100. A material boundary partition 900 which is a plate-shaped member is sandwiched between the iron core material 107 and the iron core material 108 and between the iron core material 110 and the iron core material 111. The iron core 100 is formed by laminating plural laminated blocks, and a lamination surface partition 800 which is a plate-shaped member is sandwiched at part between the laminated blocks. The details of the material boundary partition 900 and the lamination surface partition 800 will be described later with reference to FIG. 4.

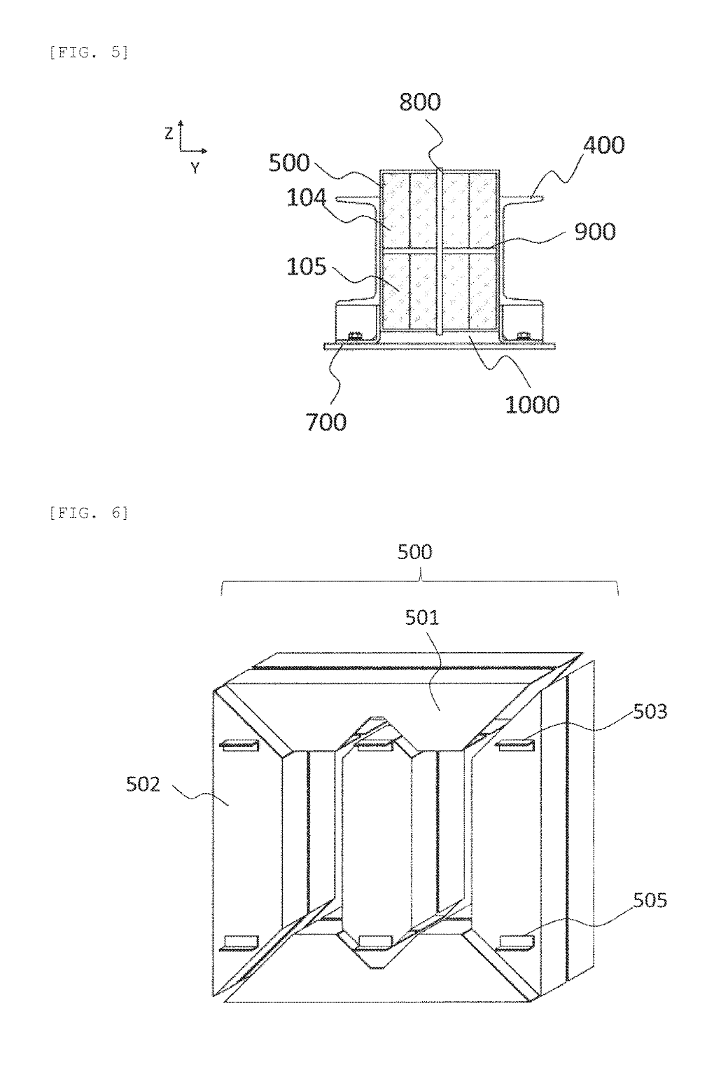

Explaining the structure of the iron core 100, first, nomenclature of respective portions will be explained. The iron core 100 includes a core portion (a periphery of a cross section A) which is part of three iron core legs and arranged inside the coil 200 in FIGS. 1 and 2, and a yoke portion (periphery of a cross section B) connecting three iron core legs and fixed by the upper fasteners 300 or the lower fasteners 400. In the embodiment, the core portion indicates part of the iron core members 107, 108, 110 and 111, which is arranged inside the coil 200, and the yoke portion indicates iron core members 101, 102, 104 and 105. The details of the core portion will be described with reference to FIG. 4 and the details of the yoke portion will be described with reference to FIG. 5 later.

FIG. 3(b) is a front view of a first laminated block, and FIG. 3(c) is a front view of a second laminated block which is laminated adjacent to the first laminated block. FIG. 3(d) is a front view showing a state where FIG. 3(b) and FIG. 3(c) overlap each other. Although the material boundary partition 900 is omitted for simplifying the explanation in respective drawings, the material boundary partition 900 is inserted between the iron core materials 101 and 102, between 104 and 105 and between 110 and 111, respectively.

Each laminated block is formed by laminating, for example, approximately 15 to 20 pieces of same iron core materials in the depth direction of the paper though not shown in FIGS. 3(b) and (c) as they are front views. FIGS. 3(b) and (c) have a relationship of facing each other with their backs. The iron core 100 in FIG. 3(a) is formed by laminating plural pieces of FIG. 3(d) and inserting the material boundary partition 800 and the lamination surface partition 900, which is, namely, formed by alternately laminating the laminated block of FIG. 3(b) and the laminated block of FIG. 3(c).

When respective first and second laminated blocks are laminated so that a boundary portion between the iron core material 110 and the iron core material 111 makes a straight line as well as the first and second laminated blocks are laminated so that a boundary portion between the iron core material 107 and the iron core material 108 makes a straight line as shown in FIG. 3(d), the first and second laminated blocks are shifted by a given width at a position of joints 115. The shift amount is determined in accordance with the shape of the central iron core leg, which is, for example, approximately ten-odd millimeters and can be arbitrarily selected by design specifications. In the embodiment, the joint 115 between the iron core material 111 of the central iron core leg and the iron core material 101 of the yoke portion are formed so as to be 45 degrees with respect to a direction (Z-axis direction) in which the iron core material 111 of the central iron core leg extends, however, the angle of the joint 115 is not limited to this. In the case of the embodiment, two iron core materials 101 arranged right and left with the iron core material 110 and the iron core material 111 forming the central iron core leg interposed therebetween are made to be two members which are divided by the existence of the central iron core leg. However, in the case where the joint 115 is formed, for example, at an angle of 60 degrees with respect to the direction (Z-axis direction) in which the iron core material 111 extends, these iron core materials 101 are not divided and may be formed as one connected member. When these are formed as one member, assembling performance of the upper yoke portion is improved. As described above, the angle of the joints 115 can be changed in consideration of workability at the upper yoke portion, and it is also possible to make angles on an inner peripheral side and an outer peripheral side different. For example, when the angle on the inner peripheral side is made so as to increase magnetic resistance, magnetic fluxes concentrated to the inner periphery can be moved to the outer peripheral side to uniform magnetic fluxes at the iron core legs.

A plate thickness of an amorphous alloy is extremely thin as compared with a silicon steel sheet and the thickness tends to be uneven. Accordingly, it is possible to adopt a method of increasing flatness of the laminated block by combining a portion with a large plate thickness and a portion a small plate thickness in good manner. It is also possible to obtain necessary flatness by inserting a thin insulating material or the silicon steel sheet between the laminated blocks.

FIG. 4 shows a cross-sectional view of the cross section A of FIG. 3(a). In the vicinity of the center of the iron core material 107 and the iron core material 108 in a lamination direction (Y-axis direction), the lamination surface partition 800 having a flat surface parallel to the iron core material is arranged. The plate-shaped material boundary partition 900 is arranged between the laminated block of the iron core material 107 and the laminated block of the iron core material 108. The lamination surface partition 800 and the material boundary partition 900 are manufactured by metal and so on insulated by an insulating material, varnish or the like. The outer periphery of the iron core material 107 and the iron core material 108 is surrounded by the core fixing metal fitting 500 which is not shown in FIG. 3(a). The core fixing metal fitting 500 is formed of materials with high strength such as iron and epoxy resin. The iron core 100 is formed by laminating the iron core material 107 and the iron core material 108 along the core fixing metal fitting 500 and the material boundary partition 900. End surfaces of the amorphous alloy tend to be irregular as compared with end surfaces of the slit-processed silicon steel sheet. Therefore, workability of lamination can be improved by arranging the material boundary partition 900 and the core fixing metal fitting 500 functioning as guide members on both sides of the iron core as in the embodiment. As end surfaces of the joints 115 can be also aligned according to the above structure, loss in the joints 115 can be suppressed and iron core characteristics can be improved. Furthermore, the lamination surface partition 800 can function as a reference surface used at the time of laminating the iron core as well as can function as a core in the lamination direction, therefore, the strength of the iron core leg can be increased and the iron core with high resistance to vibration at the time of transportation can be obtained.

It is necessary to pay attention so as not to form a circuit in the same direction as the coil by the lamination surface partition 800 when the core fixing metal fitting 500 is a conductor such as iron, however, the attention is not necessary when the core fixing metal fitting 500 is formed of the insulating material. Even when the core fixing metal fitting 500 is formed of the conductor, the lamination surface partition 800 can be arranged at an arbitrary position in the lamination direction (Y direction) which is not shown as long as at least one break is formed.

Varnish is applied to contact portions of the core fixing metal fitting 500, the lamination surface partition 800 and the material boundary partition 900 at the laminating work, thereby fixing these members to some degree in a dry process after the assembly and obtaining the structure having higher strength.

FIG. 5 shows a cross-sectional view of a cross section B of FIG. 3(a). The outer periphery of the iron core material 104 and the iron core material 105 is surrounded by the core fixing metal fitting 500 which is not shown in FIG. 3(a). Fastening in the lamination direction is performed by the lower fasteners 400 which is not shown in FIG. 3(a). In the iron core of the amorphous alloy, not only it is difficult to expect improvement of strength by fastening as in the case of the silicon steel sheet but also excessive fastening causes tremendous deterioration of characteristics. Accordingly, it is necessary that the iron core has the structure not depending on the strength for securing safety in the assembling work and for resisting transportation. The core fixing metal fitting 500 and the material boundary partition 900 according to the invention also have a function of preventing excessive fastening by the upper fasteners 300 or the lower fasteners 400, and sizes are determined so that the fastening from both sides in the lamination direction becomes a proper size. The lower fasteners 400 have fixing portions to the base 700 positioned at a lower part of the inner structure and fixed by bolts. A clearance 1000 between the base 700 and the core fixing metal fitting 500 is filled with an insulating material such as a press board to prevent movement to the lower part.

FIG. 6 shows a view obtained by extracting only the fixing structure of the iron core from FIG. 1. Core fixing metal fitting and fastener connecting portions 503 for connecting to the upper fasteners 300 and the lower fasteners 400 are provided at upper and lower ends of the core fixing metal fitting 500, which are fastened to the upper fasteners 300 and the lower fasteners 400 by bolts as shown in FIG. 1. The coil 200 is arranged at a position between the upper and lower core fixing metal fitting and fastener connecting portions 503.

Next, a lamination procedure of the iron core will be explained. As the upper yoke portion is lastly formed, other portions which are the upper fasteners 300, the lower fasteners 400 and the core fixing metal fitting 500 as a framework are first fastened by bolts. To explain the procedure by especially citing the fastening between the lower fasteners and the core fixing metal fitting 500, the lower fasteners are arranged on both sides with the iron core 100 interposed therebetween. First, one lower fastener of them, for example, a left lower fastener 400 and the core fixing metal fitting 500 are fastened by a bolt. The left lower fastener 400 and the iron core fixing metal fitting 500 in FIG. 5 are rotated by 90 degrees to fall sideways though they are already in a standing state in FIG. 5. Next, iron core materials are laminated from above (from the right side in the standing state in FIG. 5) by using the iron core fixing metal fitting 500 as a guide member. After that, the other lower fastener is attached and both lower fasteners 400 are fastened by using the fastener fastening studs 600 (see FIG. 1). Concerning the core portion, the laminating is performed in the same manner and the iron core is inverted by 90 degrees by an inverting machine to be in a state where the coil 200 can be inserted, and the coil 200 is inserted.

In FIG. 6, when a member in a region arranged in the yoke portion is denoted by 501 and a member in a region arranged in the core portion is denoted by 502 in the iron core fixing metal fitting 500, an insulating material such as a press board is interposed between 501 and 502 for adjusting the size, it is also possible to integrally form 501 and 502 by welding the place. Cylindrical stoppers for preventing excessive fastening may be disposed in the fastener fastening studs 600, and structural strength can be improved by increasing a cross-sectional area of the cylinder and increasing the contact area.

Next, the lamination in the upper yoke portion will be explained. In the joints 115 (see FIG. 3d) where the yoke portion iron core is combined with the core portion iron core, it is required that respective iron cores are arranged accurately with each other. However, respective pieces of the amorphous alloy are extremely thin, therefore, deflection, unfastening of the laminated body and so on may occur in the laminated block of the amorphous alloy, and workability is low on its own. Accordingly, iron plate guide members having a thickness of 1 mm or less are arranged at the outermost periphery in the lamination direction of the yoke portion iron core, and the yoke portion iron core is sandwiched between the iron plate guide members. According to the structure, the yoke portion iron core can be stabilized and workability can be improved. The iron plate guide members may have a length approximately equivalent to that of the yoke portion iron core for stabilizing the entire yoke portion iron core, or may have a shorter length and be arranged only in the vicinity of the joints 115.

As the assembling work, the inner peripheral side iron core is first assembled, then, the material boundary partition 900 is arranged, and lastly, the outer peripheral side iron core is assembled. The iron plate guide members are not removed until insertion of laminated bodies of several blocks is completed, and are collectively removed after the laminate has a certain thickness and the amorphous alloy is stabilized. The work is repeated to thereby insert all blocks.

It is also possible to use a PET resin film having a thickness of approximately 0.05 mm instead of the iron guide member. In this case, the film is arranged so as to protrude from the yoke portion iron core by approximately 1 mm in the longitudinal direction of the yoke portion iron core, and respective blocks of the upper yoke may be laminated by using the protrusion of the film as a guide. In the case of the thin film, the guide may be sandwiched in advance at the time of laminating in the core portion.

As another method for stabilizing the upper yoke portion at the time of assembling work, there is a method of coating the periphery of joints with resin. A small amount of coating material is applied to end surfaces of the yoke portion iron core which has been cut and laminated for each laminated block. As coating materials, soft resins with least deterioration of characteristics are preferably used, however, hard materials with high deterioration of characteristics may be used according to work environment or the size of the iron core.

### Embodiment 2

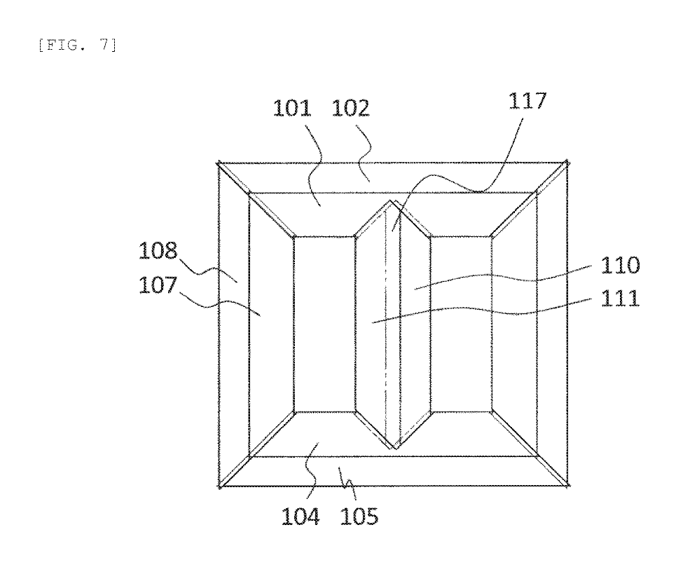

FIG. 7 shows a front view of the iron core 100 according to a second embodiment of the invention. In the same manner as FIG. 3d of the first embodiment, pairs of iron core laminated bodies which are iron core materials 107 and 108, 101 and 102, and 104 and 105 are arranged side by side, in which the first laminated block and the second laminated block are laminated. A point different from the first embodiment is that material widths of the iron core materials 107 and 108 differ from each other. Similarly, material widths differ also between 101 and 102 as well as between 104 and 105. In the core portion of the central iron core leg in three iron core legs, the laminated block of the iron core material 110 with a smaller material width and the laminated block of the iron core material 111 with a larger material width are arranged in parallel, and these are laminated alternately in right and left sides for each laminated block in the same manner as the first embodiment. In the case of the second embodiment, the iron core materials 111 with the larger material width overlap in laminated blocks adjacent in the lamination direction by a prescribed width. A region between a boundary between the iron core materials 110 and 111 in the first laminated block and a boundary between the iron core material 110 and 111 in the second laminated block corresponds to an overlapping margin 117 of the iron core material 111. It is difficult to arrange the material boundary partition 900 in the central iron core leg due to the existence of the overlapping margin 117, however, the strength of the iron core leg is secured even when the material boundary partition 900 is omitted as the overlapping margin 117 functions as a shaft. The overlapping margin 117 corresponds to the difference of material widths between materials 107 and 108, 101 and 102, 104 and 105, and 110 and 111. The difference can be arbitrarily selected so as to correspond to the shape of the iron core for the purpose of omitting the material boundary partition 900.

In the explanation of the embodiment, the example in which the iron core materials 110 and 111 used for the first laminated block is used for the second laminated block by turning over the materials 110 and 111 as they are. However, also in the embodiment in which laminated blocks are formed by combining materials having different iron core widths, the boundaries of iron core materials can be aligned in the first laminated block and the second laminated block by making the shape of the iron core material forming the second laminated body different from the shape of the iron core materials 110 and 111 forming the first laminated block. In this case, the material boundary partition 900 can be inserted into the boundary.

In the yoke portion, the iron core material with the larger material width is used for the inner side iron core materials 101 and 104, and the iron core material with the smaller material width is used for the outer side iron core materials 102 and 105, thereby integrating the iron core materials 101 and 104 completely separated in the first embodiment into one member respectively.

The embodiment considers that characteristics of the amorphous alloy will be deteriorated as the material width is increased. That is, the iron core with the larger material width and worse characteristics is arranged on the inner peripheral side, thereby dispersing magnetic fluxes concentrated to the inner peripheral side toward the outer peripheral side and obtaining effect of improvement in characteristics by uniforming magnetic fluxes in the iron core legs.

It is also possible to provide a hook shape by a cutter having a notch of the hook shape at material cut portions on both sides to be joined to thereby perform guidance and prevent deviation at the time of lamination.

### Embodiment 3

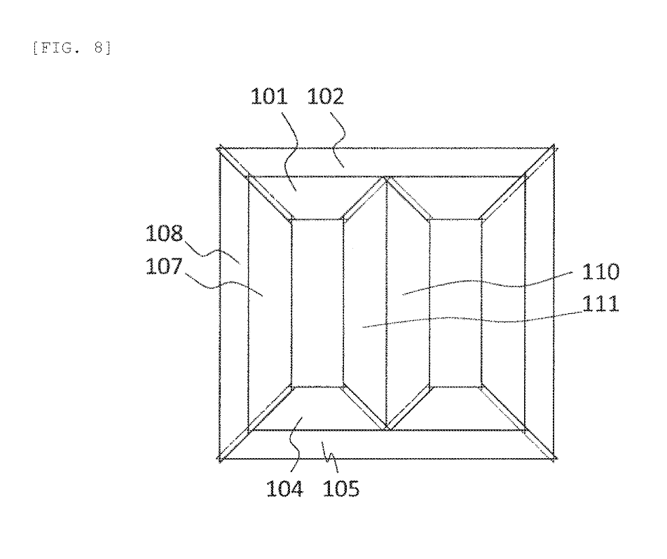

FIG. 8 shows a front view of the iron core 100 according to a third embodiment of the invention. In the same manner as FIG. 3d of the first embodiment and FIG. 7 of the second embodiment, pairs of iron core laminated bodies which are iron core materials 107 and 108, 101 and 102, and 104 and 105 are arranged side by side, in which the first laminated block and the second laminated block are laminated. In the embodiment, the iron core materials 110 and 111 forming the central iron core leg have the same width, however, the iron core materials 107 and 108 forming the outer side iron core leg and the iron core materials 101 and 102 in the yoke portion have different iron core widths from each other, respectively. As the central iron core leg is formed by combining two iron cores which have the wider width in iron cores having two kinds of widths forming the outer side iron core legs, the iron core cross-sectional area is larger in the central iron core leg than in the outer side iron core legs. Since the central iron core leg is arranged so as to be sandwiched between both-side iron core legs and the coil 200, heat tends to be accumulated and is difficult to be cooled as compared with both-side iron core legs. When the iron core is not sufficiently cooled and the temperature of the iron core is increased, characteristics of the iron core deteriorate. In the embodiment, the cross-sectional area of the central iron core leg in which deterioration in characteristics tends to occur due to the temperature increase is widened as compared with the iron core legs on both sides, thereby reducing the load applied to the central iron core leg and suppressing deterioration in characteristics at the central iron core leg. Two iron core materials with the wider material width are combined and used for the central iron core leg, thereby increasing the cross-sectional area of the iron core to be larger than that of the outer side iron core legs. Conversely, it is possible to reduce the cross sectional area of the iron cores to be smaller than that of the central iron core leg by combining two iron core materials with the smaller material witch for the outer side iron core legs. When the central iron core leg is formed by aligning the iron core materials having the same material width, the material boundary partition 900 is preferably arranged in the same manner as Embodiment 1.

### Embodiment 4

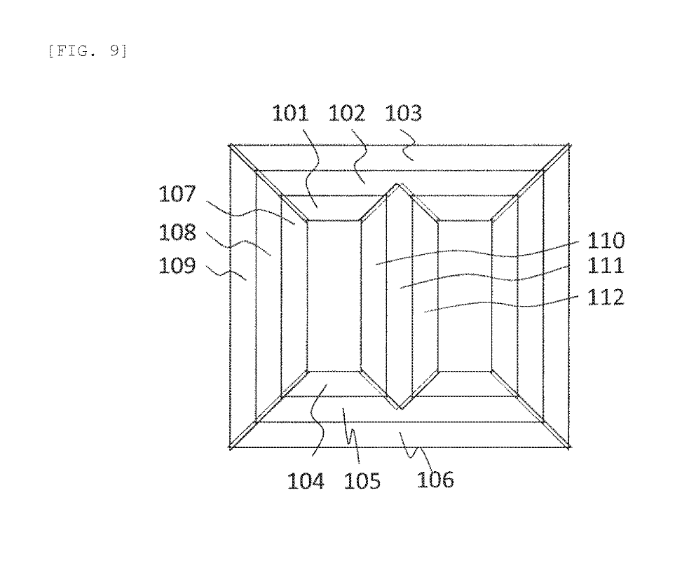

FIG. 9 shows a front view of the iron core 100 according to a fourth embodiment of the invention. In the present embodiment, three iron core materials are arranged side by side, and the first laminated block and the second laminated block are laminated, which differs from the first to third embodiments. The central iron core leg is formed by iron core materials 110 to 112. When the material having the same shape is used for the iron core materials 110 and 112, kinds of materials can be suppressed and manufacturing costs can be reduced. The example in which three iron cores having the same material width are aligned is shown in FIG. 9, however, the iron core material having a different width may be used for part of the iron core. The iron core 100 formed by aligning four or more iron core materials is also an example of the embodiment of the invention. The iron core formed by using a material having a different material width for at least one part of the iron core is also an example of the invention.

### Embodiment 5

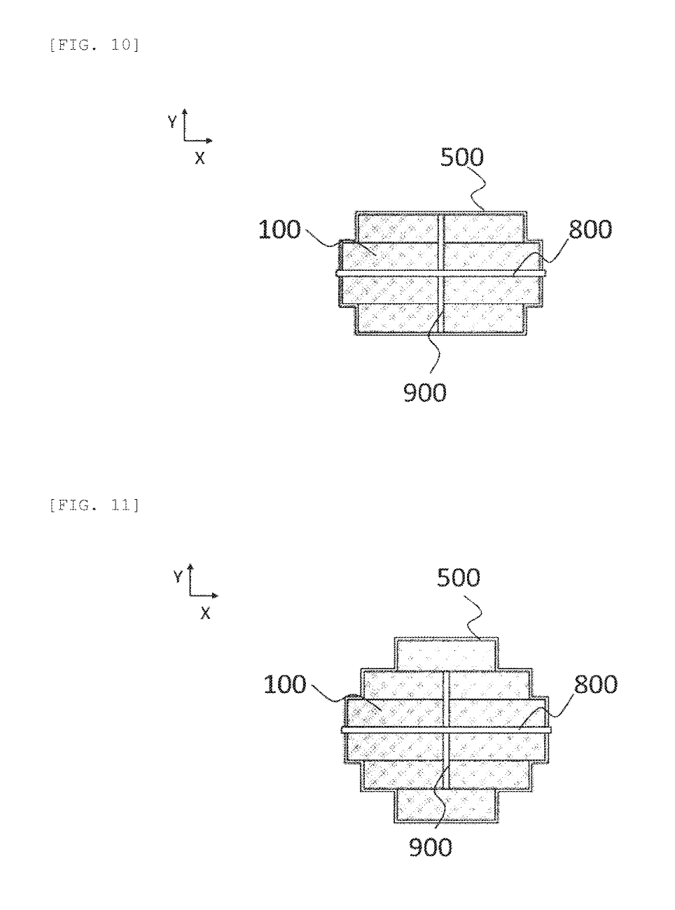

FIG. 10 shows a cross-sectional view of an iron core leg of the iron core 100 according to a fifth embodiment of the invention.

When the coil 200 has a cylindrical shape, a large clearance is generated between the coil 200 and the core fixing metal fitting 500 in the shape of the iron core 100 shown in FIG. 4, and a ratio of the area (space factor) of the iron core occupied inside the coil is reduced. Accordingly, a width of the iron core material positioned in the vicinity of the center in the lamination direction (Y-axis direction) with respect to the iron core 100 is formed to be wider than widths of the iron core material arranged on outer sides in the lamination direction (Y-axis direction). According to the structure, the cross-sectional shape of the iron core 100 becomes a shape close to the cylindrical shape of the coil, therefore, the clearance between the coil 200 and the core fixing metal fitting 500 is reduced and the space factor can be increased. An example in which iron core widths of three kinds of more are formed as shown in FIG. 11 is also part of the embodiment. When the iron cores with a larger kinds of widths are combined to form the cross-sectional shape of the iron core to be an approximately circular shape, the space factor can be further increased. In the embodiment in which iron cores with many kinds of widths are combined as described above, the structure of the iron core becomes complicated and assembling performance is reduced, however, the reduction of assembling performance can be suppressed by using the core fixing metal fitting 500 as a guide for the laminating work of the iron core as in the invention. A reinforcing effect can be also obtained after the laminating.

### Embodiment 6

FIG. 11 shows a cross-sectional view of an iron core leg of the iron core 100 according to a sixth embodiment of the invention. An outer shape of the iron core is an approximately cylindrical shape of the coil 200 by making iron core widths different according to positions in the lamination direction (Y-axis direction). Another feature of the present embodiment is a point that the outermost periphery in the lamination direction is formed by the single laminated block and plural laminated blocks are not aligned in the X-axis direction. Accordingly, the material boundary partition 900 does not reach the outermost periphery in the lamination direction (Y-axis direction). As mentioned in the explanation of FIG. 10, the core fixing metal fitting 500 has a multistage shape extending along the outer shape of the iron core.

In the present embodiment, the material widths are clearly different in the laminated block in the outermost periphery of the lamination direction (Y-axis direction) and in an adjacent inner side laminated block, and the fastening load applied from the side of the laminated block in the outermost periphery is received only by part of regions in the inner side laminated block. In order to reduce the deviation of the load, for example, an iron plate, a silicon steel sheet, a thick press board and the like which are wider than the area of the inner side laminated block may be inserted between the outermost laminated block and the adjacent inner side laminated block.

The dimension of a circumscribed circle of the core fixing metal fitting 500 is formed to be slightly larger than an inner periphery of the coil 200, and the coil is inserted while being deformed by contact, thereby maintaining a good contact state after the insertion. The dimensional adjustment is performed also by drying of a coil inner bobbin and the dimension after lubrication, and may be in a range of within 1 mm. The bobbin in this case is preferably a metal such as iron from an aspect of strength. The bobbin arranged in an inner periphery of the coil can be functioned as an insertion guide used when inserting the core fixing metal fitting 500 into the coil by performing processing of a groove having the same shape as a corner of the core fixing metal fitting 500 at a position corresponding to the corner after the iron core is inserted. The bobbin can also have a function of fixing the iron core after the iron core is inserted. The bobbin in this case is preferably a press board having, for example, a thickness of approximately 3 mm.

### Embodiment 7

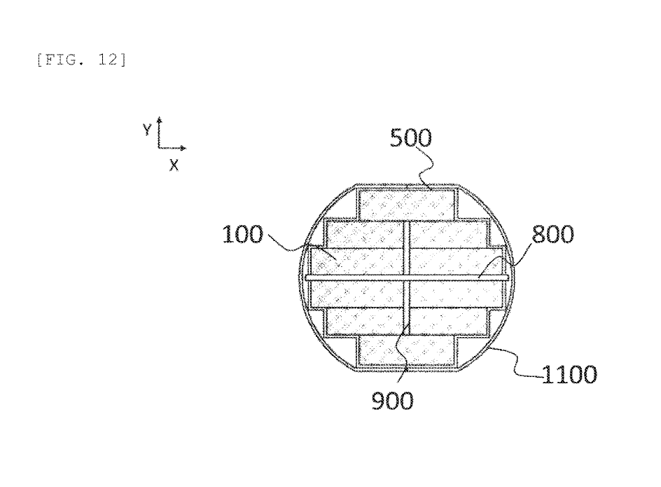

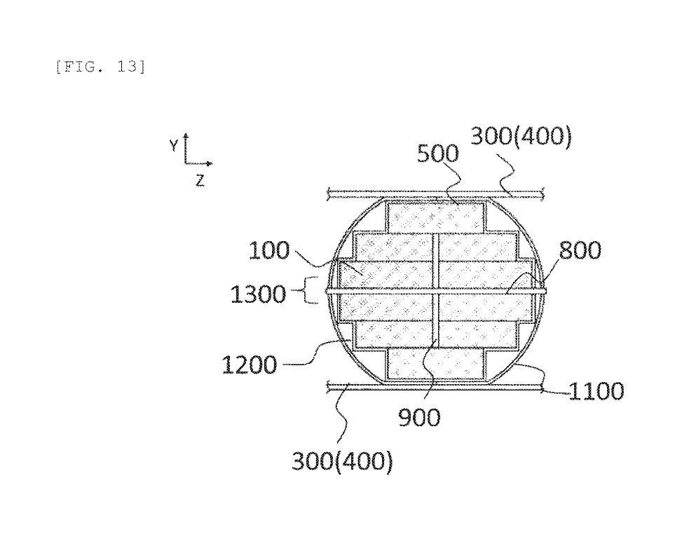

FIG. 12 shows a cross-sectional view of an iron core leg of the iron core 100 according to a seventh embodiment of the invention. In the present embodiment, a cylindrical periphery fixing material 1100 is arranged around the core fixing metal fitting 500 of FIG. 11. The periphery fixing material 1100 connects two members having a semicircular shape on an extension line of the material boundary partition 900 to form an approximately circular shape. As a material, a press board or an iron plate is preferable in an oil-filled transformer, and plastic, a resin or an insulating paper is preferable in a molded transformer. As it is easy to open and close by human power when using a thin insulating material and the like, one member having an approximately cylindrical shape with an opening which can be opened and closed may be used instead of using two semicircular members by being combined. Even in a hard and thick material such as an iron plate or a press board which is difficult to be opened and closed by human power, one member having the approximately cylindrical shape can be used as long as it has the opening with a size allowing the iron core material to be inserted. The periphery fixing material 1100 is fixed by being sandwiched between the outermost periphery of the iron core 100 in the lamination direction (Y-axis direction) and the upper fastener 300 or the lower fastener 400 in the yoke portion, and is fixed by an insulating tape and so on over an circumferential direction at positions where the fastener is not arranged such as the core portion. When the embodiment is applied to the molded transformer in which the appearance is particularly important, the joint surface and the inner structure can be hidden. It is also possible to suppress accumulation of dust and dirt on the surface of the iron core 100 or on the outer peripheral surface of the core fixing metal fitting 500. Furthermore, a soundproof effect can be also obtained.

Even in the case of adopting the method of forming the outer shape of the iron core 100 into an approximately circular shape as in the fifth embodiment and the sixth embodiment, it is extremely difficult to form a perfect circle because so many kinds of iron core widths are necessary to realize the shape. According to the present embodiment, the outer periphery of the periphery fixing material 1100 has a shape extending along the inner periphery of the coil 200, therefore, the iron core 100 and the coil 200 can be firmly fixed even when the outer periphery of the iron core 100 is not formed into the perfect circle. In the oil-filled transformer, varnish is applied to the inner periphery of the coil 200 and bonding is performed in a dry process to thereby suppress displacement of members.

In the case of the large-capacity transformer, it is necessary to largely secure an insulation distance between the iron core 100 and the coil 200. A cooling duct is arranged in a clearance between the iron core 100 and the coil 200, thereby improving cooling performance while securing the insulation distance.

### Embodiment 8

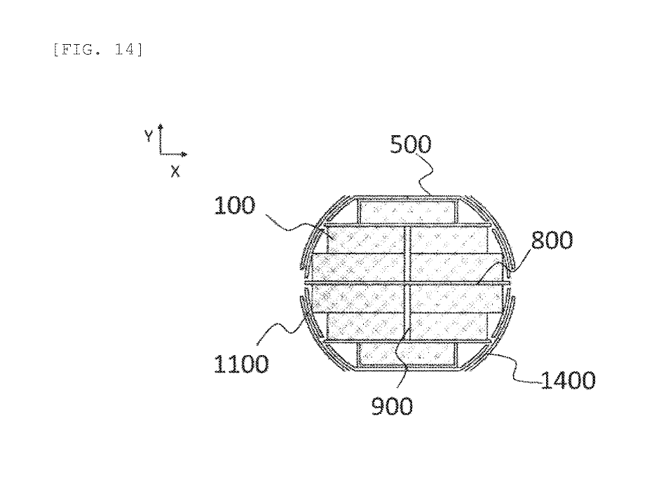

FIG. 13 shows an iron core cross-sectional view in the yoke portion of the iron core 100 according to an eighth embodiment of the invention. An iron core fixing member 1200 formed of an insulator is arranged instead of the core fixing metal fitting 500 according to the first to seventh embodiments, and the periphery fixing material 1100 having an arc shape which is welded to the upper fastener 300 and the lower fastener 400 is arranged at the outside thereof, thereby fixing the iron core 100. The periphery fixing material 1100 is made of iron as it is welded. The lamination surface partition 800 according to the present embodiment is formed of an insulating material, which is fixed by being sandwiched by boundary portions 1300 of the periphery fixing material 1100, therefore, the periphery fixing material 1100 has a structure in which a circuit is not formed. In the case where the lamination surface partition 800 is formed of materials other than the insulator, the circuit is not formed by performing varnish processing near a contact portion between the periphery fixing material 1100 and the lamination surface partition 800, or a by a method of newly interposing the insulating material. The periphery fixing material 1100 may be partially arranged in accordance with the size of the iron core 100.

As the cross-sectional shape of the iron core becomes close to the circular shape, the area of a flat surface portion contacting the upper fastener 300 or the lower fastener 400 is reduced. In the present embodiment, the periphery fixing material 1100 is fixed to the upper fastener 300 and the lower fastener 400 by welding, therefore, the iron core can be firmly fastened and fixed even when the flat surface portion is narrow.

### Embodiment 9

FIG. 14 shows an iron core cross-sectional view of the iron core 100 according to a ninth embodiment of the invention. In the present embodiment, the lamination surface partitions 800 are arranged at plural positions in the lamination method, and holes or grooves are formed at positions corresponding to the lamination surface partitions 800 in the periphery fixing material 1100 formed in a circular shape so that the lamination surface partitions 800 are fitted thereinto. The lamination surface partitions 800 and the periphery fixing material 1100 are fitted and fixed to each other, thereby fixing the iron core material. In a periphery fixing metal fitting 1400 arranged in an outer periphery of the periphery fixing material 1100, holes are formed only at positions corresponding to the lamination surface partitions 800 arranged in the vicinity of the center of the lamination direction (Y-axis direction), and the lamination surface partitions 800 are inserted into the holes.

Whether the inserted lamination surface partitions 800 are sandwiched and fixed by the periphery fixing metal fitting 1400 or not depends on the strength of the lamination surface partitions 800, which can be arbitrarily selected.

In the respective embodiments of the invention, the laminated iron core formed of the amorphous alloy is cited as the example, however, the invention is not always limited to this, and the invention can be also applied to a laminated iron core formed of the silicon steel sheet. The invention can also be applied to a combination of the amorphous alloy and the silicon steel sheet. In the case of the iron core formed of the amorphous alloy, the reinforcing effect and productivity improvement effect of the iron core are higher than the case of the laminated iron core formed of the silicon steel sheet.

The silicon steel sheet may be used for the lamination surface partition 800, thereby improving the strength. It is also preferable that silicon steel sheets having the same material width are arranged on the front and back of the lamination surface in the laminated block of the amorphous alloy and the amorphous alloy is interposed, thereby further increasing the strength of the iron core legs and improving workability of inserting the upper yoke portion. In the case where the materials are combined as described above, characteristics are better by reducing a ratio of the silicon steel sheet. For example, when a structure in which the silicon steel sheets are arranged on both sides of 20 pieces of amorphous alloys is adopted, the silicon steel sheets occupy approximately the half of the entire iron core, therefore, an iron loss is increased as compared with the case where the amorphous alloy is 100% used. On the other hand, for example, when the ratio of the silicon steel sheet is suppressed to within 10% of the whole lamination thickness, the iron loss can be suppressed to approximately +30% with respect to characteristics of the amorphous alloy of 100%. Though the ratio of the silicon steel sheet depends on a required strength of the iron core, the silicon steel sheets are disposed, for example, in units of 10 blocks of laminated blocks of the amorphous alloy. The silicon steel sheets maybe limited only to the upper yoke portion by considering workability, and the silicon steel sheets may be applied to other leg portions.

As the fixing method of the iron core 100, a method in which round holes are made on the upper fastener 300, the lower fastener 400 and the core fixing metal fitting 500, each core portion and the yoke portion, and insulated round bars are inserted thereinto may be adopted. According to the method, the iron core can be fixed more firmly, for example, while omitting the filling of the clearance 1000 in FIG. 5.

### REFERENCE SIGNS LIST

100 iron core
115 joint
117 overlapping margin
200 coil
300 upper fastener
400 lower fastener
500 core fixing metal fitting
501 core fixing metal fitting/yoke portion
502 core fixing metal fitting/core portion
503 core fixing metal fitting/fastener connecting portion
600 fastener fastening stud
700 base
800 lamination surface partition
900 material boundary partition
1000 clearance
1100 periphery fixing material
1200 iron core fixing material
1300 boundary portion
1400 periphery fixing metal fitting

1. A laminated iron core structure comprising:
a plurality of laminated iron core blocks each configured by laminating plural iron cores which are aligned in a direction different from a lamination direction.

2. A laminated iron core structure comprising:
a laminated iron core configured by aligning a plurality of laminated iron core blocks each configured by laminating iron core materials in a direction different from a lamination direction;
a first frame extending along an outer periphery of the laminated iron core; and
a partition plate arranged between the plurality of laminated iron core blocks.

3. A laminated iron core structure formed of an amorphous alloy comprising:
a laminated iron core configured by aligning a plurality of laminated iron core blocks each configured by laminating iron core materials of the amorphous alloy in a direction different from a lamination direction;
a first frame extending along an outer periphery of the laminated iron core; and
a partition plate arranged between the plurality of laminated iron core blocks.

4. The laminated iron core structure according to claim 2,
wherein the laminated iron core has a plate-shaped member made of a material different from those of the laminated iron core blocks between the laminated iron core blocks configuring the laminated iron core in the lamination direction.

5. The laminated iron core structure according to claim 2,
wherein plural laminated iron core blocks configuring the laminated iron core have at least two kinds of material widths.

6. The laminated iron core structure according to claim 2,
wherein the laminated iron core includes at least three or more leg portion iron cores, and
an iron core cross-sectional area of an outer-side leg portion iron core in the leg portion iron cores is smaller than a cross-sectional area of an inner-side leg portion iron core.

7. The laminated iron core structure according to claim 2,
wherein an inner-side laminated iron core block in the plural iron core blocks configuring the outer side iron core legs has a wider material width than that of an outer-side laminated iron core block.

8. The laminated iron core structure according to claim 2,
wherein an inner-side laminated iron core block in plural laminated iron core blocks configuring a yoke portion iron core has a wider material width than that of an outer-side laminated iron core block.

9. The laminated iron core structure according to claim 2,
wherein the laminated iron core includes at least three or more leg portion iron cores, and
an inner-side iron core leg has an overlapping margin.

10. The laminated iron core structure according to claim 2,
wherein the laminated iron core includes at least three or more leg portion iron cores, and
an angle made by a direction in which a joint boundary portion between the leg portion iron core and the yoke portion iron core extends and a direction in which the leg portion iron core extends is 45 degrees.

11. The laminated iron core structure according to claim 2,
wherein the laminated iron core is configured by arranging laminated blocks with a wider material width in the vicinity of the center in the lamination direction and arranging laminated blocks with a narrower material width toward the outer peripheral side in the lamination direction.

12. The laminated iron core structure according to claim 2,
wherein the laminated iron core is configured by arranging a larger number of laminated blocks in the vicinity of the center in the lamination direction and arranging a smaller number of laminated blocks on the outer peripheral side in the lamination direction.

13. The laminated iron core structure according to claim 2, further comprising:
a second frame having a shape corresponding to an inner peripheral shape of a coil.

14. The laminated iron core structure according to claim 13,
wherein the second frame is welded to the fastener.

15. The laminated iron core structure according to claim 4, further comprising:
a second frame having a shape corresponding to an inner peripheral shape of a coil, and
a groove is formed in part of the second frame and the plate-shaped member is inserted into the groove.

16. A transformer comprising:
the laminated iron core structure according to claim 1;
a coil arranged near an iron core leg portion of the structure; and
a fixing metal fitting which fixes the structure.

17. A transformer comprising:
the laminated iron core structure according to claim 2;
a coil arranged near an iron core leg portion of the structure; and
a fixing metal fitting which fixes the structure.

18. A transformer comprising:
the laminated iron core structure according to claim 3;
a coil arranged near an iron core leg portion of the structure; and
a fixing metal fitting which fixes the structure.
